(19) United States
(12) Patent Application Publication
(10) Pub. No.: US 2009/0152323 A1
(43) Pub. Date: Jun. 18, 2009

(54) POSITION SCALE ON NAIL GUN

(75) Inventor: Joe LIN, San Migue La Mirada, CA (US)

Correspondence Address: BROWDY AND NEIMARK, P.L.L.C.;624 NINTH STREET, NW, SUITE 300, WASHINGTON, DC, 20001-5303, US

(73) Assignee: Sandy LIN, San Migue La Mirada, CA (US)

(21) Appl. No.: 11/957,977

(22) Filed: Dec. 17, 2007

(51) Int. Cl. B25C 7/00

(52) U.S. Cl. 227/148; 227/150

(57) ABSTRACT

A position scale for a nail gun includes a scale member, a positioning member, and an extending member. The scale member is mounted on the nail gun with a zero scale aligned with a muzzle of the nail gun. The positioning member is detachably mounted on the scale member for reciprocation along the scale member with a position portion as an index of the scale marks of the scale member. The extending member is detachably mounted on the positioning member with an extending position portion vertical to the scale member, wherein the extending member is distal to the nail gun than the positioning member.

### BACKGROUND OF THE INVENTION

1. Field of the Invention

The present invention relates generally to operation of a nail gun, and more particularly to a position scale of a nail gun.

2. Description of the Related Art

To nail an object by nails with the same interval, the object is marked, and then operator put the nails on the marks for nailing. This is not an idea way.

When fix a wood board with corner pieces, usually the board is put on the corner piece and nail them from the board. In such condition, the corner is hidden behind the board that operator is hard to identify the location of the corner piece. To overcome this problem, operator usually pre-put some marks on the board, so there is an extra work for it.

### SUMMARY OF THE INVENTION

The primary objective of the present invention is to provide a position scale for a nail gun, which may measure distance directly.

According to the objective of the present invention, a position scale, which is mounted on a nail gun including a gun body, a muzzle, a grip and a magazine, includes a scale member, a positioning member, and an extending member. The scale member, which has scale marks thereon, is mounted on the nail gun with a zero scale of the scale marks aligned with a muzzle of the nail gun. The positioning member, which has a position portion, is detachably mounted on the scale member for reciprocation along the scale member with the position portion as an index of the scale marks of the scale member. The extending member, which has an extending position portion, is detachably mounted on the positioning member with the extending position portion vertical to the scale member, wherein the extending member is distal to the nail gun than the positioning member.

### BRIEF DESCRIPTION OF THE DRAWINGS

FIG. 1 is a bottom view of a preferred embodiment of the present invention;

FIG. 2 is an exploded view of the preferred embodiment of the present invention, showing the scale member and the positioning member;

FIG. 3 is an exploded view of the preferred embodiment of the present invention, showing the scale member, the positioning member, and extending member;

FIG. 4 is a lateral view of the preferred embodiment of the present invention, showing the first operation mode; and

FIG. 5 is a lateral view of the preferred embodiment of the present invention, showing the second operation mode.

### DETAILED DESCRIPTION OF THE INVENTION

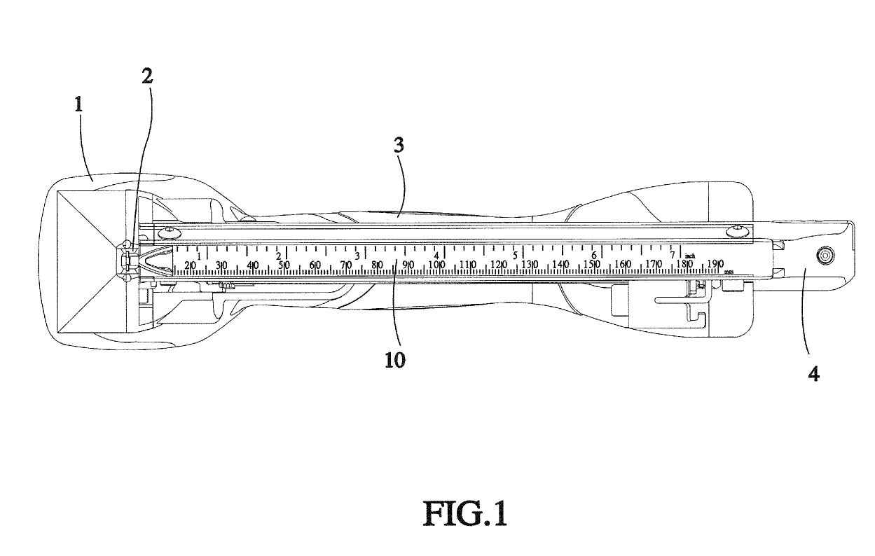

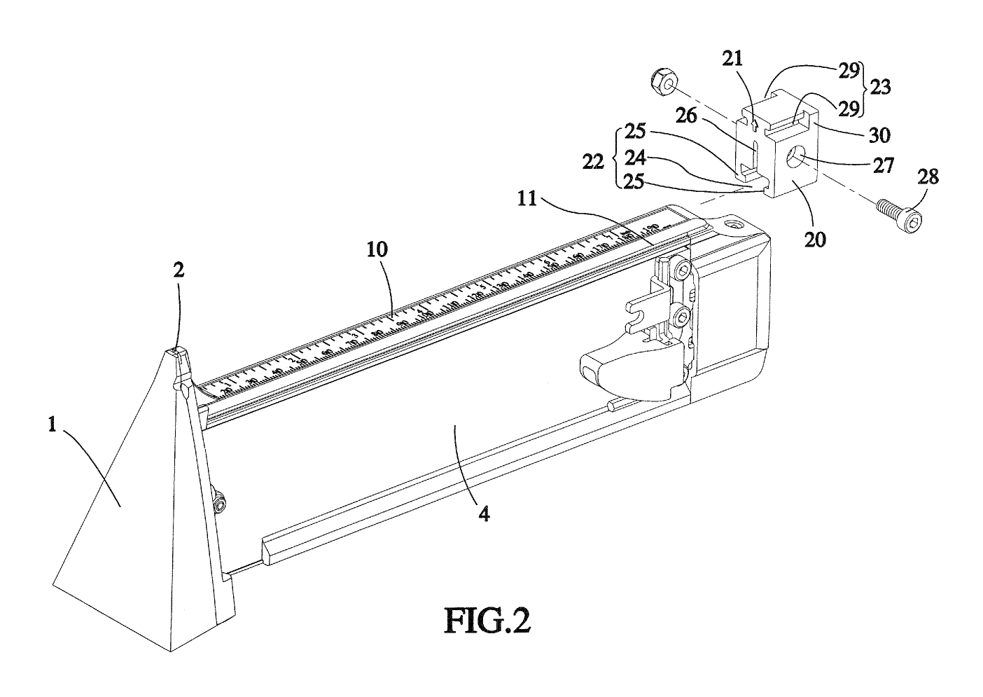

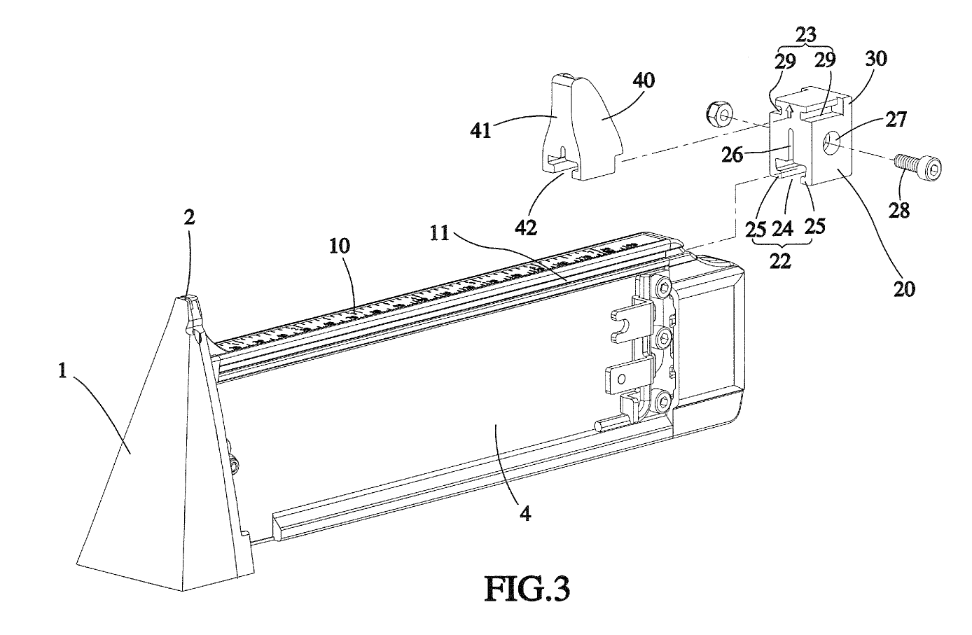

As shown in FIG. 1 to FIG. 3, a position scale of the preferred embodiment of the present invention is mounted on a conventional electrical nail gun, which includes a gun body 1, a muzzle 2, a grip 3, and a magazine 4. The position scale of the present invention is described as following:

A scale member 10, on which scale marks are provided, is mounted on the nail gun with a zero scale of the scale marks aligned with the muzzle 2. In the present invention, the magazine 4 is transversely mounted on the gun body 1 adjacent to the muzzle 2, and the scale member 10 is mounted on a bottom of the magazine 4.

A positioning member 20 is detachably mounted on the scale member 10 for manipulative reciprocation along the scale member 10. The positioning member 20 has a position portion 21 for index with the scale marks of the scale member 10. The positioning member 20 has a first coupling portion 22 and a lower coupling portion 23 at opposite. In the present invention, the positioning member 20 is a block with a slot 24 on a top thereof, two flanges 25 at opposite sides of the recess 24 and a gap 26 projected from a bottom of the slot 24. These components construct the first coupling portion 22 that the flanges 25 may be bent inwards. The positioning member 20 further is provided with a bore 27 transversely through the gap 26. A bolt 28 is inserted into the bore 27 to adjust the bend condition of the flanges 25. The lower coupling portion 23 includes two elongated slots 29 on a bottom of the positioning member 20. At an end of each of the slots 29, which is distal to the muzzle, is a top portion 30. A front side of the positioning member 20 is the position portion 21.

An extending member 40, which includes an extending position portion 41 and a coupling portion 42, is detachably mounted on the positioning member 20. Basically, the extending position portion 41 is vertical to the scale member 10, and the extending member 40 like an extrusion of the scale member 10. In the present invention, the extending member 40 is a block with a slot (the coupling portion 42), similar to the first coupling portion 22 of the positioning member 20, to be engaged with the slots of the second coupling portion 23 of the positioning member 20 for combination of the positioning member 20 and the extending member 40. A front side of the block is the extending position portion 41, and the front side (the position portion 21) of the positioning member 20 is even with the extending position portion 41 of the extending member 40.

For movement and clipping of the positioning member 20, the scale member 10 is provided with two elongated slots 11 at opposite thereof that the flanges 25 of the first coupling portion 22 of the positioning member 20 is engaged with the slots 11 of the scale member 10.

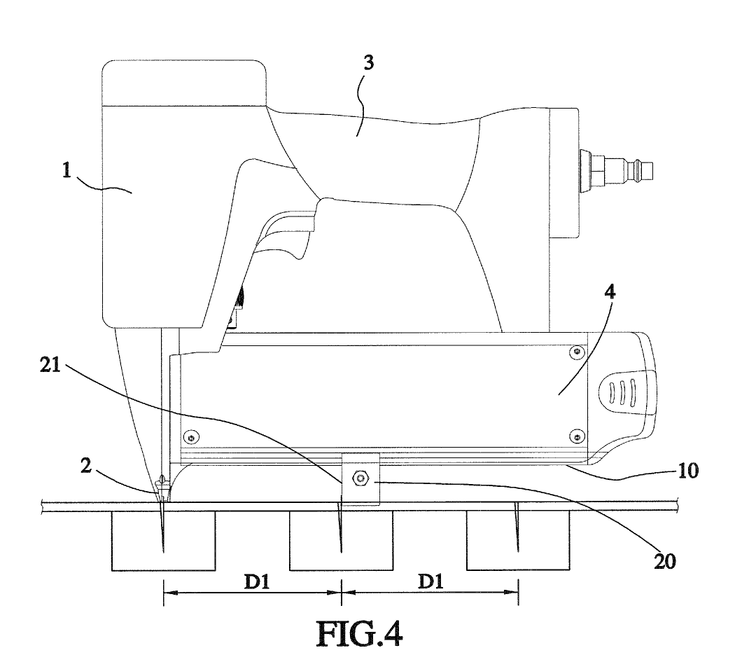

The present invention provides two operation modes. The first operation modes is only the usage of the positioning member 20. In this mode, operator moves the positioning member 20 to a desired portion, and turns tight the bolt 28 to fix the positioning member 20 at that position that a distance between the position portion 21 and the muzzle 2 is fixed. For example, a wood board B and a corner piece F on a back of the wood board B is shown in FIG. 4, when a distance D1 between centers of the wood board B and the corner piece F is 10 centimeters, the positioning member 20 is moved to a position that the scale member marked with 10 cm and fixes it as described above that the distance between the position portion 21 and the muzzle 2 is 10 cm. So, after the operator makes the first shoot of nail on the board B, he/she could have the position portion 21 against the nail and make another shoot. Repeat the step above, it will have nails on the board with the same interval, 10 cm. As a result, operator may shoot nails on an object with the same interval and without having to pre-mark the object.

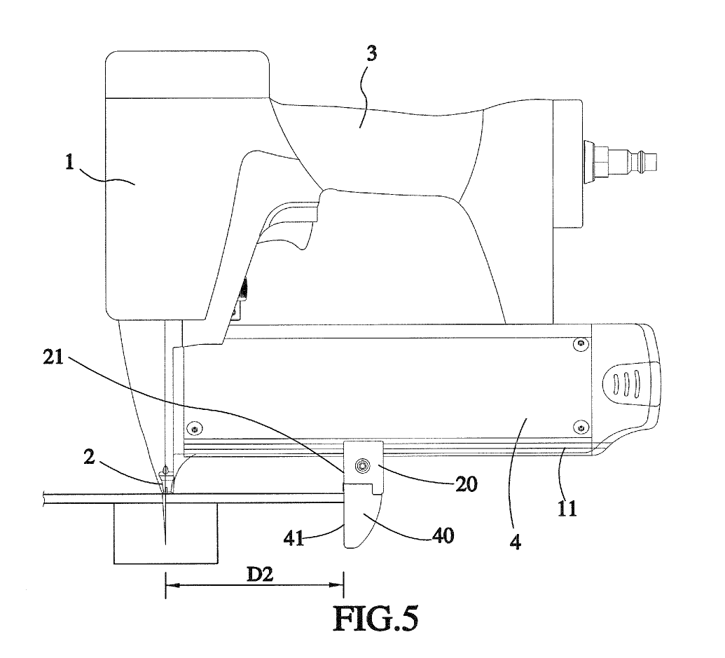

The second operation mode is the usage of the extending member 40. The extending member 40 is mounted on the positioning member 20 by the way as described above, and the positioning member 20 and the extending member 40 are moved to a desired portion and fixed thereat by tightening the bolt 28. For example, as shown in FIG. 5, to shoot nail of the board B with the corner piece F on a back of the board B, and we had known the location of the corner piece F is D2, 10 cm for example, from an edge of the board B, operator has to fix the positioning member 20 and the extending member 40 at 10 cm position, and then lean the extending position portion 41 of the extending member 40 against the edge of the board B so that the nail will be nailed into the corner piece F when the operator make the shoot without the pre-mark work.

The description above is a few preferred embodiments of the present invention and the equivalence of the present invention is still in the scope of the claim of the present invention.

What is claimed is:

1. A position scale, which is mounted on a nail gun including a gun body, a muzzle, a grip and a magazine, comprising:
a scale member, which has scale marks thereon, mounted on the nail gun with a zero scale of the scale marks aligned with the muzzle of the nail gun;
a positioning member, which has a position portion, detachably mounted on the scale member for reciprocation along the scale member with the position portion as an index of the scale marks of the scale member; and
an extending member, which has an extending position portion, detachably mounted on the positioning member with the extending position portion vertical to the scale member, wherein the extending member is distal to the nail gun than the positioning member.

2. The position scale as defined in claim 1, wherein the positioning member has a first coupling portion and a second coupling portion at opposite.

3. The position scale as defined in claim 2, wherein the positioning member is a block with a slot is provided on a top thereof, two flanges on opposite of the slot and a gap projected from a bottom of the slot whereby the flanges are flexible to be bent inwards to form the first coupling portion.

4. The position scale as defined in claim 3, wherein the positioning member further has a bore transversely through the gap and a bolt inserted into the bore to adjust a bend condition of the flanges.

5. The position scale as defined in claim 3, wherein the second coupling portion of the positioning member includes two elongated slots on the block and two stop portions on ends of the slots.

6. The position scale as defined in claim 2, wherein the extending member includes a coupling portion to be engaged with the second coupling portion of the positioning member for combination of the extending member and the positioning member.

7. The position scale as defined in claim 6, wherein the coupling portion of the extending member has a slot on the extending member.

8. The position scale as defined in claim 1, wherein the position portion of the positioning member is a front side of the positioning member.

9. The position scale as defined in claim 8, wherein the extending member is a block with a front side to be the position portion that is even with the position portion of the positioning member.

10. The position scale as defined in claim 3, wherein the scale member is mounted on a bottom of the magazine.

11. The position scale as defined in claim 10, wherein the scale member is provided with two slots on opposite sides to be engaged with the flanges of the first coupling portion of the positioning member.
